(19) United States
(12) Patent Application Publication
(10) Pub. No.: US 2011/0000054 A1
(43) Pub. Date: Jan. 6, 2011

(54) COUPLING APPARATUS

(76) Inventor: EDMUND F. TRIFARI, JR., West Hartford, CT (US)

Correspondence Address: MCCORMICK, PAULDING & HUBER LLP, CITY PLACE II, 185 ASYLUM STREET, HARTFORD, CT, 06103, US

(21) Appl. No.: 12/851,657

(22) Filed: Aug. 6, 2010

Related U.S. Application Data
(63) Continuation-in-part of application No. 12/268,496, filed on Nov. 11, 2008.

(51) Int. Cl. F16B 2/20

(52) U.S. Cl. 24/457; 24/570

(57) ABSTRACT

A coupling apparatus for attaching a recycling container to a waste container comprises a back plate having a length and a width that lies in a first plane, a crossover portion rigidly connected to the back plate and lying in a plane approximately transverse to the back plate and a coupling portion rigidly connected to the crossover portion opposite the back plate, the coupling portion having a substantially U-shaped profile and sized to receive a handle of one of the recycling container and the waste container.

### CROSS REFERENCE TO RELATED APPLICATIONS

This application is a continuation-in-part of U.S. application Ser. No. 12/268,496, filed on Nov. 11, 2008, entitled Coupling Apparatus” (Attorney Docket No. 5362-0001), the disclosure of which is hereby incorporated by reference herein in its entirety.

### FIELD OF THE INVENTION

This invention relates to a coupling apparatus for use with portable containers. The invention is intended to promote recycling by reducing the effort and certain inconveniences required to participate in municipal recycling programs.

### BACKGROUND OF THE INVENTION

With typical household waste collection, residents roll their wheeled waste containers out to the street curb to be emptied on specified days. Those residents choosing to recycle their recyclable items store them in separate bins positioned at the curbside next to the waste container for collection.

The importance of recycling and the expense of disposing of household and business refuse has created a demand for greater participation in municipal recycling efforts. Many municipalities provide free bins to households so that recyclable items can be conveniently sorted and stored prior to collection. Some municipalities, business concerns, and schools have instituted incentive programs to encourage conservation and recycling. Despite such efforts, the overall percentage of households that consistently recycle remains low.

A typical portable waste container 22 and bin 10 are shown in FIG. 1. Bin 10 is rectangular in shape having four planar walls and a central cavity for placing items into. The shorter ends of the bin are referred to as the grip ends 14, 16. Along the top edge of the bin 10 is a reinforced edge 12 that gives rigidity to the bin 10. The reinforced edge 12 is reinforced by a series of ribs that are underneath the edge 12 connecting it to the walls of the bin 10 (not shown). On both of the grip ends 14, 16 of the rectangular bin 10 is a handle 18, 20 that is formed into the reinforced edge 12. The portion of the reinforced edge 12 where the handles 18, 20 are located is free of ribs and has planar inside portion (not shown) so that fingers can grip the handles 18, 20 to hold the bin 10.

The waste container 22 has a base with four planar walls, a front wall 24, a rear wall 26, and two side walls 28, 30. The walls form and inside surface 94 and an outside surface 96 of the waste container 22. The bottom of the rear wall 26, at the base, has a wheel axle 34 running through it with two large wheels 32 attached at each end of the wheel axle 34. At the top of the rear wall 26 is a handle 37. Typically, once the waste container 22 is filled it is to taken to a collection site by tilting the waste container 22 onto the wheel axis 36 and rolling the waste container 22 to a collection site. Therefore, the waste container 22 has a rest position 38 and a transport position 40 (rolling position).

Lack of participation in recycling efforts can be caused by the physical effort and inconvenience of transporting multiple containers from the home to the curbside. While a rollout waste container is relatively easy to move, the recycling bins typically lack wheels, are often heavy, and must be lifted and carried separately in a second or even third trip. For many residents, the need alone to make multiple trips from the home to the curb is enough to discourage recycling.

What is needed is an apparatus that can easily attach an empty recycling bin to a waste container while the bin is empty. This way it can be filled while already attached to a waste container, eliminating the need to lift a full recycling bin and trying to hook it on a hanger, or carrying the recycling bin to the curb. In addition, what is needed is an apparatus that can easily attach a filled recycling bin to a waste container for transport.

A caddy for carrying bins is disclosed in U.S. Pat. No. 5,845,915. The caddy provides for the stackable storage of various size bins used for holding items such as mail, recycling materials, and piece parts allowing each bin to rotate when the device is tilted during movement of the bins so as to prevent spillage of the items placed within the bins. When used for holding of recycling bins, a homeowner may move the bins from the home to the curb without lifting of the bins yet provide ease of access. The bins are maintained in substantially parallel and horizontal plane to the ground when placed in an upright and tilted position. Wheels and a handle of the device are predisposed to operate as a stand to assist in maintaining the positional rotation of each bin.

The problem with U.S. Pat. No. 5,845,915 is that more than one trip is still required to take out the waste container and the bins. The cart is cumbersome, not easily stored, and can require time consuming adjustment. Further, the device of the U.S. Pat. No. 5,845,915 patent does not allow for coupling of a bin to a waste container.

Prior art coupling devices for enabling the transporting of recycling bins with a waste container are deficient largely in that they are made of a wire-shaped structure or the like. Due to the wire-shaped design, most of the force of the weight of the recycling bin is concentrated on the wire hook portions. This can lead to the deformation of the wire hanger, the recycling bin, or the waste container. Also, when lifting the recycling bin up to the hooks, great attention must be paid so that both hook portions are in contact with the recycling bin or it will cause the hook(s) to deform and possibly cause the contents of the recycling bin to spill. Because all of the weight of a bin and its contents are placed on the wire hooks, the wire has to be substantially thick in diameter, this makes it harder to couple a bin to the hooks because there is not much clearance between the wall and the inside of the overhanging edge of a bin.

A further disadvantage of wire-shaped configurations is that the recycling bin or the like are often configured with a series of laterally spaced ribs around the periphery of the bin surface and bin surface lip. The wire-shaped bracket or hook must then be adjusted to avoid being in registration with a rib; otherwise the bracket will not engage the bin properly. The edge of the recycling bin where the ribs are located are not designed to carry the load of the bin and its contents. Additionally, wire-shaped prior art devices due to their lack of rigidity can be easily bent even when not in use. For example, dropping or stepping on a wire-shaped structure could cause it to deform or possibly break making the structure unusable. Further, for the wire-shaped designs to hold a bin with any stability the hooks of the design must be spread out as far as possible (beyond the width of a bin handle). Due to the lack of rigidity of the wire-shaped devices it may not be possible to keep the bin and its contents stable. Further, the repeated bending of the wire-shaped devices can lead to fatigue and breakage of the wire-shaped devices.

Other prior art devices for enabling the transport of bins have a rectangular frame that hooks onto the outside of a waste container. The rectangular frame catches on the bottom of the outer rolled edge of the recycling bin providing support. The problem with devices of this type is that the recycling bin has to be lifted up and over the frame so that the recycling bin can be placed inside or taken out of the frame. This can be difficult for many people, especially if the bin is filled with recyclable items. If a bin is improperly set on/in the frame, the frame could easily be bent or twisted from the weight of the bin and its contents. Another problem with these types of assemblies is that they are bulky due to the fact that they have to fit around the outside of a recycling bin. Due to their inherent bulk they can get in the way and are not easily stored when not in use. Further, the rectangular frame would have to be adjusted for different size bins, resulting in more effort and time being taken.

A further problem with the rectangular framed and wire shaped prior art devices is that when the waste container and recycling bin is tipped so that they can be rolled to its desired location, the recycling bin's orientation is not parallel to the ground (level) allowing spilling of the items inside the recycling bin.

Still, another problem with the above mentioned devices is that they do not utilize a grip that recycling bins have formed into them. These grips are reinforced so that a recycling bin can be carried by these grips without damage to the bin. The wire frame type devices contact the lip/ribs of the bin, which are not designed to carry a load and usually results in damage to the recycling bin. Further, the device that uses a rectangular frame to support a bin around the edges is again subject to the weakness of the ribs of the container because they are not designed to carry the load of a recycling bin and its contents.

The present invention solves the above-mentioned problems by enabling the transport of recyclable items contained in one or more separate bins together with the waste container from the home to the curbside in a single trip.

In addition to the above-noted inconveniences associated with wheeled refuse containers and standard recycling bins, many towns and municipalities across the nation are now switching to, or have already switched to, a single-stream recycling system in which all paper fibers and containers are mixed together in a collection truck, instead of being sorted into separate commodities (newspaper, cardboard, plastic, glass, etc.) and separate bins by the resident and handled separately throughout the collection process. The switch to single stream recycling has been driven by an effort to improve recovery rates. In such a system, collection of recyclable items is facilitated by the use of another wheeled container or cart, identical or substantially similar to a wheeled refuse container, instead of the smaller and, heretofore standard, rectangular recycling bins. These new single stream containers are generally 64 gallons and have a similar configuration to existing wheeled refuse containers.

As will be readily appreciated, the switch to a large, wheeled container for recyclable materials now requires residents in these municipalities to wheel at least two large, wheeled containers to the curb, one for standard refuse and one for single-stream recycling. Notably, none of the above-mentioned prior art devices are capable of making the task of wheeling two large containers any easier for residents participating in single-stream recycling programs.

In view of these problems and concerns associated with refuse and single stream recycling participation, there is a need for a device that enables the transport of recyclable items contained in one or more separate wheeled containers, together with the waste/refuse container, from the home to the curbside in a single trip.

### BRIEF SUMMARY OF THE INVENTION

It is an object of the invention to provide a coupling apparatus adapted for use with a waste container, and for coupling a recycling bin or waste-size wheeled recycling container so that users need to make only a single trip from the home to the street curb when transporting their waste and recyclable items for collection.

It is another object of the invention to provide a coupling apparatus that easily attaches a filled bin, which can be of substantial weight, to a rollout container without having to lift the entire bin off the ground, making it manageable for senior citizens or others typically of lesser strength to participate in recycling efforts.

It is another object of the invention to provide a coupling apparatus attachment that is durable and hard to deform.

It is another object of the invention to provide a coupling apparatus that is relatively inexpensive and easy to manufacture.

It is another object of the invention to provide a coupling apparatus that is relatively lightweight.

It is another object of the invention to provide a coupling apparatus that holds a bin substantially level when at rest and when the container is tilted for transport to avoid spillage of the bin's contents.

It another object of the invention to provide a coupling apparatus that has no welds, rivets, or moving parts.

It is another object of the invention to provide a coupling apparatus that which is easily removed from and applied to the waste container without damaging the walls of the container or bin, and will not interfere with trash collection efforts.

It is another object of the present invention to provide a coupling apparatus that can be easily removed from a container and stored when not in use.

It is another object of the present invention to provide a coupling apparatus that can remain attached to the handle of a container being towed so as to be positioned and ready for reuse.

It is another object of the invention to provide a coupling apparatus in which a bin can be attached to a waste container without lifting up the entire bin.

It is another object of the present invention to provide a coupling apparatus which allows an empty bin to be attached to a waste container and then filled so that when the bin is full it is already attached to the waste container and can be brought to a waste collection site in one trip.

It is another object of the invention to enable the transport of multiple bins together with a portable waste container from the home to the street curb in a single trip.

It is another object of the invention to reduce the physical effort required to transport bins to a collection site.

According to one aspect of the present invention; a coupling apparatus includes a coupler group adapted for securing the apparatus to a container. A receiver group is rigidly attached to a coupler group by an extender having a first and second end, and is adapted for securing a bin used for containing articles. The container and bin are movable together in a single trip between a storage site and a waste collection site. The term “bin” is defined broadly herein to include any container, such as but not limited to a box, frame, or bag used for storage. The term “rigid”, “rigidly”, or “rigidity” is defined herein as substantially inflexible, unyielding, having the ability to avoid twisting, bending and/or warping.

According to another embodiment of the invention, the coupler group includes a back plate having a length and a width that lies in a first plane, an extender having a first end and a second end, wherein said first end is rigidly connected to an end of said back plate and lies in a second plane at a first angle to said first plane of said back plate and having a width coextensive with width of the back plate.

According to another embodiment of the invention, the receiver group includes a receiver back plate rigidly connected to the second end of said extender lying in a third plane at a second angle to said second plane of said extender. A receiver lip is rigidly connected to said receiver back plate lying in a plane at a v-shaped groove angle from the said third plane of said receiver back plate, wherein said receiver back plate and said receiver lip form a v-shaped groove.

According to another embodiment of the invention, the first angle, the second angle, and the v-shaped groove angle are chosen so that a bin is approximately level in both a rest position and a transport position to avoid spillage of any bin contents.

According to another embodiment of the invention, the first angle is about 95 degrees, the second angle is about 100 degrees, and the v-shaped groove angle is about 30 degrees.

According to another embodiment of the invention, the coupling apparatus is formed of a continuous piece of metal.

According to yet another embodiment of the invention, the coupling apparatus is made of rigidly connected braces.

According to yet another embodiment of the present invention, a coupling apparatus for coupling a wheeled container to a rolling refuse container includes a back plate having a length and a width that lies in a first plane, a crossover portion rigidly connected to the back plate and lying in a plane approximately transverse to the back plate, and a coupling portion rigidly connected to said crossover portion opposite said back plate, the coupling portion having a substantially U-shaped profile and sized to receive a handle of one of the recycling container and the waste container. The apparatus also include an angled retaining portion for retaining the handle of the trailing container in the U-shaped channel.

### BRIEF DESCRIPTION OF THE DRAWINGS

FIG. 1 is a simplified schematic illustration of a typical container and bin.

FIG. 2A is a simplified schematic illustration of a bin, a coupling apparatus of the present invention, and a container in a rest position.

FIG. 2B is a simplified schematic illustration of the bin, coupling apparatus of FIG. 2A shown with the container in a transport position.

FIG. 3 is a simplified schematic illustration of a perspective view of a coupling apparatus provided by the present invention;

FIG. 4 is a simplified schematic illustration of a side cross sectional view of the coupling apparatus of FIG. 3, showing a first plane in which a back plate lies, a second plane in which a extender lies, a third plane in which a receiver back plate lies, and a fourth plane in which a receiver lip lies;

FIG. 5 is a simplified schematic illustration of an enlarged view of the coupler group and a receiver group of the coupling apparatus of FIG. 3;

FIG. 6 is simplified schematic illustration of the coupling apparatus of FIG. 3 in a standard mount configuration;

FIG. 7 is a simplified schematic illustration of the coupling apparatus of FIG. 3 in a lip mount configuration;

FIG. 8 is a simplified schematic illustration of the coupling apparatus of FIG. 3 in a dual mount configuration;

FIG. 9 is a simplified schematic illustration of the coupling apparatus of FIG. 1 in a hidden mount configuration;

FIG. 10 is a simplified schematic illustration of the coupling apparatus of FIG. 1 mounted on a recessed bar of a typical waste container;

FIG. 11 is a simplified schematic illustration of the coupling apparatus of FIG. 1 mounted on an upper lip edge of a typical waste container; and

FIG. 12 is a simplified schematic illustration of the coupling apparatus of FIG. 1 made of rigidly connected braces.

FIG. 13 is a simplified schematic illustration of a waste container with an integrated coupling apparatus.

FIG. 14 is a simplified schematic illustration of a bin with an integrated coupling apparatus.

FIG. 15 is a simplified schematic illustration of a typical rolling refuse container and rolling single-stream recycling container.

FIG. 16 is a simplified schematic illustration of a rolling refuse container and a rolling recycling container coupled together using the coupling apparatus of the present invention.

FIG. 16a is a simplified schematic illustration of the coupling apparatus of the present invention coupling a rolling refuse container with a rolling recycling container.

FIG. 17 is a perspective view of a coupling apparatus in accordance with an embodiment of the present invention.

FIG. 18 is a side plan view of the coupling apparatus of FIG. 17 in accordance with the present invention.

### DETAILED DESCRIPTION OF THE PREFERRED EMBODIMENTS

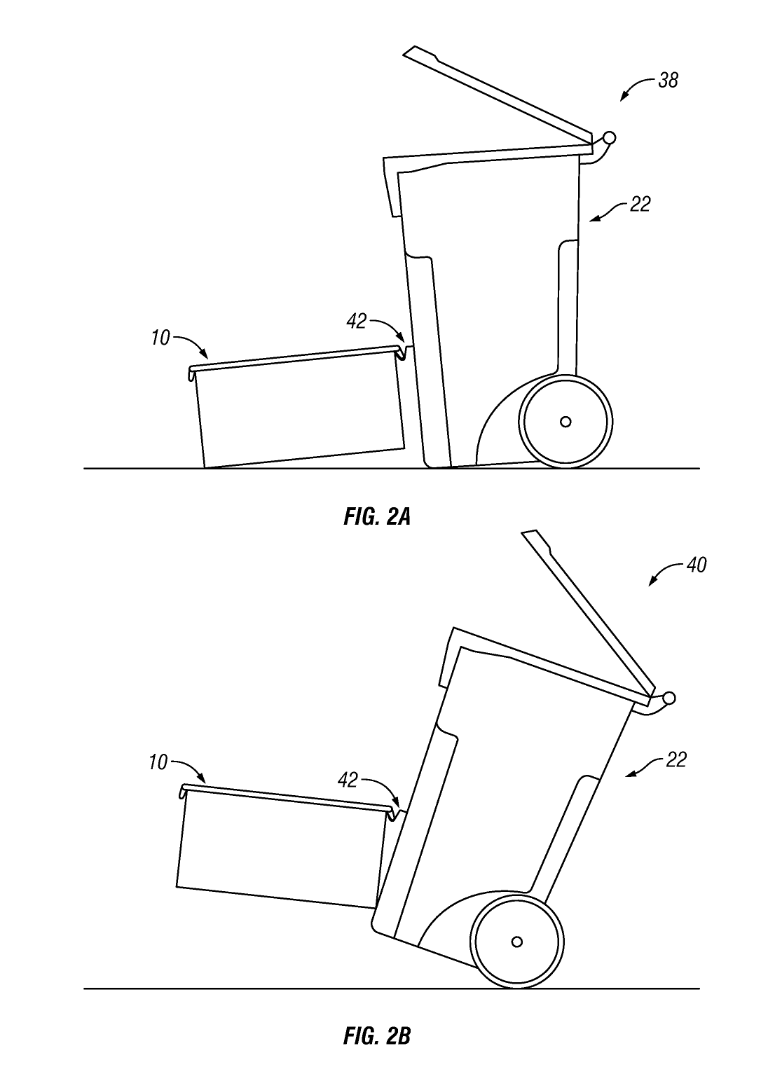

Referring now to FIG. 2, a coupling apparatus 42 according to the present invention is illustrated coupling a bin 10 to a container 22. The coupling apparatus 42 is especially adapted for use on a residential, rollout waste container 22. The coupling apparatus 42 is designed to hold a recycling bin 10 used for storing recyclable items, such that a rollout waste container 22 and a recycling bin 10 can be conveniently transported together in a single trip between a storage site in or near a home and a collection site near the street curb. It is understood that the coupling apparatus 42 may be used for carrying/holding bins 10 of different sizes and shapes including those suitable for storing yard debris, such as leaves, fallen branches, and the like.

Further, as shown in FIG. 2, the coupling apparatus 42 allows an empty bin 10 to be attached to a waste container 22 and filled with recyclable items, so that the bin 10 does not have to be lifted when full and can be brought to its collection site without carrying it separately. The coupling apparatus 42 is designed so that the bin 10 when coupled to a waste container 22 remains substantially level, in both the rest position 38 and when being tilted back into the transport position 40. Being level prevents the contents of the bin 10 from spilling.

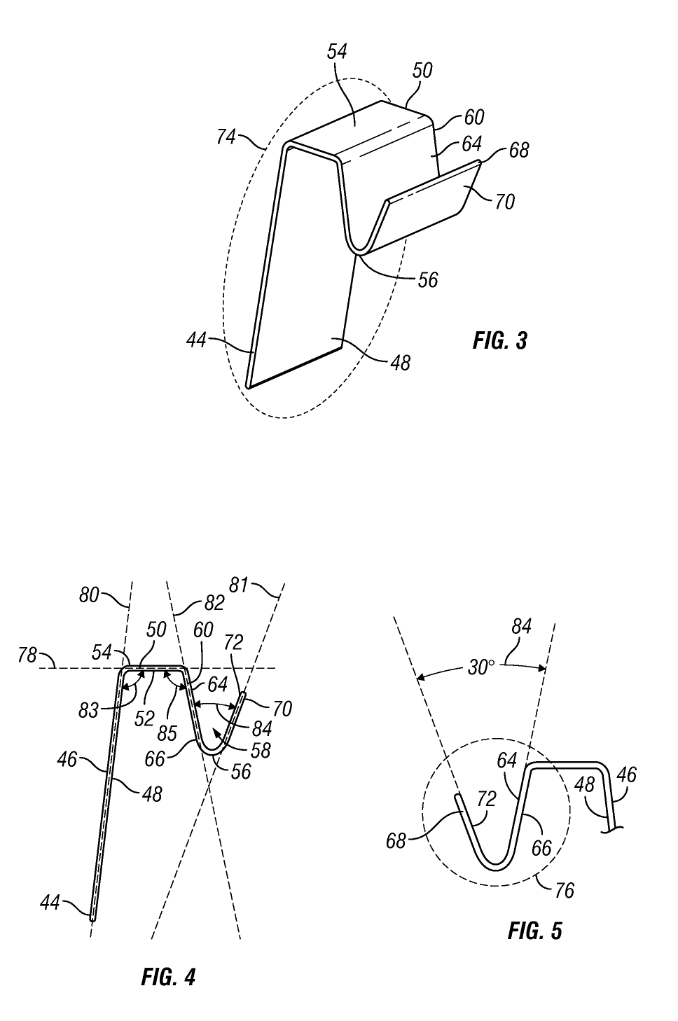

FIG. 3 is a perspective view of a coupling apparatus 42. The portion of the coupling apparatus 42 that is encircled by the dotted lines is the coupler group 74. FIG. 4 is a cross sectional view of the coupling apparatus 42. The coupling apparatus 42 can be one piece, or multiple pieces, but should be made sufficiently rigid so that there is little flex.

Referring to FIGS. 3, 4, and 5, the coupling apparatus 42, in a preferred embodiment, is comprised of a single piece of bent metal such as, but not limited to, aluminum or steel. The coupling apparatus 42 is sized so that it will fit either on the upper lid edge 88 of the waste container 22 or the recessed bar 90 of the waste container 22. The coupling apparatus 42 can be constructed from a variety of materials with a tensile strength and rigidity sufficient to support the load intended, which in standard applications is about 20 pounds, provided its lateral strength maintains the recycling bin's 10 level orientation, such that spilling will not occur. The material of the coupling apparatus 42 is preferably thin to allow for easy engagement of the bin 10 to the coupling apparatus 42. The thickness of the metal can be increased for an application in which the recycling bin 10 and its contents are heavier than the standard 20 pounds.

Due to the rigid design of the solid piece of metal of the preferred embodiment, the coupling apparatus 42 will not bend or deform due to the load of a full bin 10. This is, in part, because the weight of the bin 10 and its contents is distributed across the entire width of the coupling apparatus 42. Further, there are no rivets, welds, or moving parts in the preferred embodiment that can wear and/or break over time. The coupling apparatus 42 is small, does not require any assembly, and is easily removed and stored when not in use.

The coupling apparatus 42 in its preferred embodiment has a width of about 10 cm, a length of approximately 13 cm, and a depth of about 7 cm. The width of the coupling apparatus 42 is chosen such that it will fit into a handle 18, 22 of a recycling bin 10, which is usually about 4 inches or 10 cm wide. The coupling apparatus 42 has an approximately planar back plate 44 with a width and a length that lie in a first plane represented by the dashed line numbered 23 in FIG. 4. The back plate 44 has an outer surface 46 and an inner surface 48. The back plate 44 is rigidly attached to a first end 51 of an extender 50 of approximately 3 cm in length and a has a width that is coextensive with the back-plate 44 that lies in a second plane indicated by the dotted line 21. The first plane 78 of the back plate 44 and the second plane 80 of the extender 50 are at a first angle 83 to each other.

Rigidly attached to a second end 53 of the extender 50, is a receiver back plate 60, which is about ⅓ the length of the back plate 44, or about 4 cm. The receiver back plate 60 has a width coextensive with the back plate 44 and the extender 50, and lies in a third plane represented by the line 25. The second plane 80 of the extender 50 and the third plane 82 of the receiver back plate 60 are at a second angle 85 to each other. Following the receiver back plate 60 is a bend 56 that forms an angle referred to as a v-shaped groove angle 84. In a preferred embodiment the v-shape groove angle 84 is about 30 degrees and is bent away from the first plane 78 of the back plate 44. After the bend 56 is planar member about 3 cm in length, called a receiver lip 68. The receiver lip 68 lies in a fourth plane represented by line 31 in FIG. 4. The fourth plane that the receiver lip 68 lies in is at the v-shaped groove angle 84 from the third plane 82 that the receiver back plate lies in.

The first angle 83, the second angle 85, and the v-shaped groove angle 84 along with the lengths of the back plate 44, extender 50, receiver back plate 60 and receiver lip 68 of the coupling apparatus 42 are important and selected to ensure easy attachment of a bin 10 to a waste container 22 and to maintain the bin 10 substantially level when the waste container 22 is in the rest position 38 and transport position 40. The bin 10 being level avoids spillage of the contents of the bin 10. The angles 83, 84, 85 may vary depending on the application and types of containers 22 and bins 10 being used. In the preferred embodiment the first angle 83 is about 95 degrees, the second angle 85 is about 100 degrees and the v-shaped groove angle 84 is about 30 degrees.

FIG. 5 is an enlarged illustration of a coupler group 74 that is encircled by the dashed line in FIG. 3. The extender 50 is such that an inside of the back plate 44 is a continuous surface which leads into the extender 50 to create an inside surface 52 of a extender 50, an inside surface 66 of a receiver back plate 60, and then an outside surface 70 of a receiver lip 68. The outside surface 64 of the back plate 44 forms a continuous surface, that when followed, forms an outer surface of the extender 50, an outside surface 64 of the receiver back plate 60 between the extender 50 and the bend 56, and then through the bend 56 to form an inside surface 72 of the receiver lip 68. The outside surface 64 of the receiver back plate 60 and the inside surface 72 of the receiver lip 68, along with the bend 56, form a v-shaped groove 58. The outside surface 64 of the receiver back plate 60 and the inside surface 62 of the receiver lip 68 form an angle called the v-shaped groove angle 84. The receiver back plate 60, the bend 56, and the receiver lip 68 that form the v-shaped groove 58 can be referred to as a receiver group 76 and is encircled by a dotted line in FIG. 5.

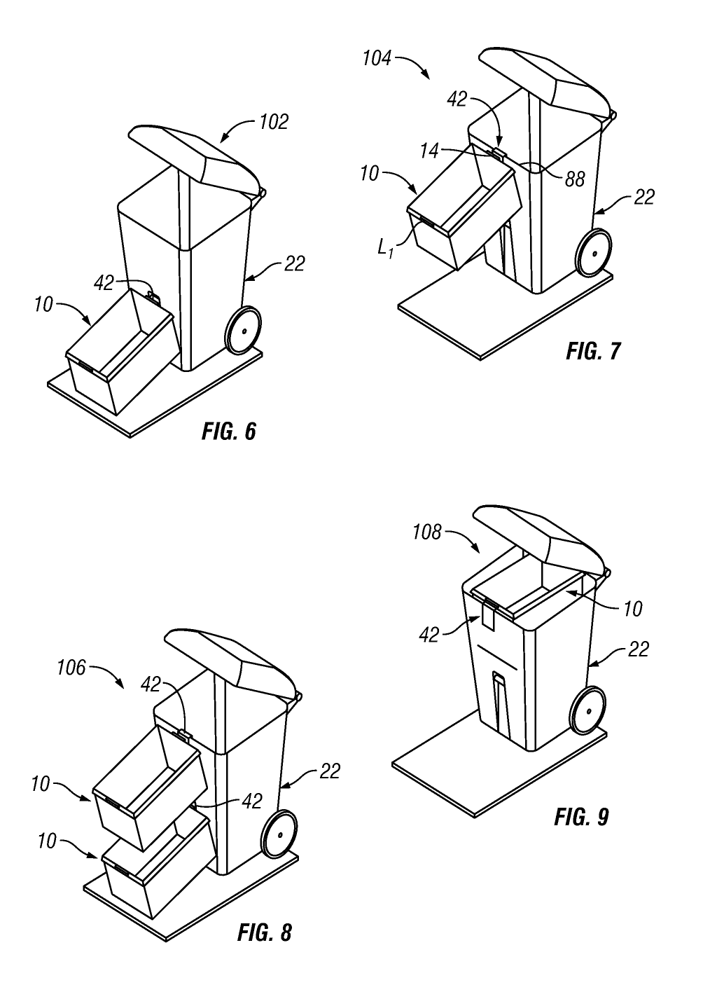

Referring to FIG. 6, this illustration shows the coupling apparatus 42 in a standard mount configuration shown generally by reference number 102. Here, the coupling apparatus 42 is placed over a recessed bar 90 of the waste container 22. The inside of the extender 50 rests on the recessed bar 90. FIG. 9 shows an enlarged illustration of the coupling apparatus 42 resting on the recessed bar 90.

One advantage provided by the coupling apparatus 42 is that, in this configuration 102, a full or empty recycling bin 10 can easily be placed onto the coupling apparatus 42 without having to lift the recycling bin 10 completely off the ground. (see FIGS. 6, 7) The recycling bin 10 can be attached to the waste container 22 by merely lifting only a grip end 14, 16 (handle end) of the recycling bin 10 and placing it in the v-shaped groove 58 so that a handle 18, 20 of the grip end 14 rests on the inner portion of the receiver lip 68 and the outside portion of the receiver back plate 60, which form the v-shaped groove 58. The receiver lip 68 has a length such that the recycling bin 10 will not slip off because the receiving lip 40 extends beyond the plane of the recycling bin 10 (as would fingers of a hand). The recycling bin 10, especially when full, will create a torque on the coupling apparatus 42 making it want to rotate about the recessed bar 90. The coupling apparatus 42 is prevented from over-rotating due to the back plate 44. When the coupling apparatus 42 rotates, the outside surface 46 of the back plate 44 contacts a surface behind 92 the recessed bar 90, stopping the rotation and stabilizing the position of the recycling bin 10 relative to the waste container 22.

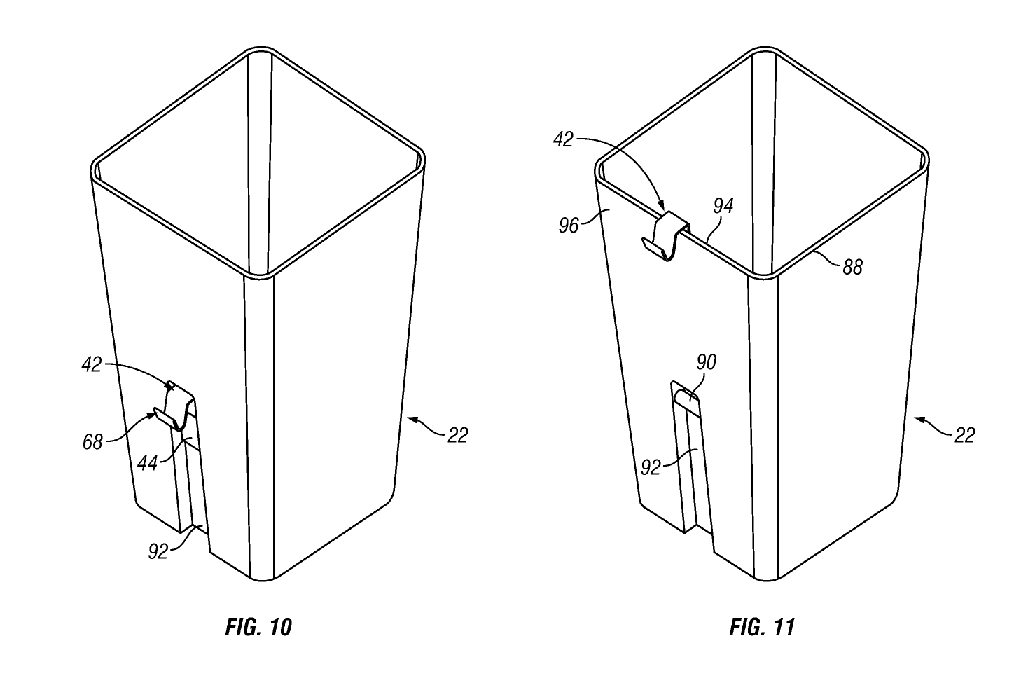

Referring to FIG. 7, the coupling apparatus 42 is in a lid mount configuration shown generally by the reference number 104. FIG. 10 shows a zoomed illustration of the coupling apparatus 42 resting on the upper lid edge 88. In a lid mount configuration 104, the inside of the extender 50 rests on the upper lid edge 88. The back plate 44 of the coupling apparatus 42 is on an inside surface 94 of the waste container 22. The inside surface 66 of the receiver back plate 60 rests against the outside surface 96 of the waste container 22. The grip end 14 or 16 of the bin 10 is placed in the v-shaped groove 58 so that the handle 18 or 20 of the grip end 14 or 16 rests on the inner surface 62 of the receiver lip 68 and the outside surface 64 of the receiver back plate 60, which form the v-shaped groove 58 at the v-shaped groove angle 84 (see FIG. 5).

The length of the receiver lip 68 is such that the recycling bin 10 will not slip off because the receiver lip 68 extends beyond the plane of the recycling bin 10 (as would fingers of a hand). The planar receiver lip 68 lies flat against the inside of the handle 18 or 20 (not shown). The recycling bin 10, especially when full, will create a torque on the coupling apparatus 42 making it want to rotate about the upper lid edge 88. The coupling apparatus 42 is prevented from over-rotating due to the length of the receiver back plate 60. When the coupling apparatus 42 rotates, the inside surface 66 of the receiver back plate 60 contacts the outside surface 96 of the waste container 22 preventing it from over rotating so that the coupling apparatus 42 will support the bin 10. The length of the receiver back plate 60 is selected to limit rotation to an angle such that the recycling bin 10 will be substantially level when the waste container 54 is both at the rest position 38 and when rotated to the transport position 40.

FIG. 8 illustrates a dual mount configuration, which combines the configurations of FIGS. 6 and 7 and is shown generally by reference number 106. In the dual mount configuration 106, one coupling apparatus 42 is placed on the upper lid edge 88, and one on the recessed bar 90 of the waste container 22, so that two bins 10 can be easily coupled to and moved along with the waste container 22.

Referring to FIG. 9, it is an illustration of a hidden mount configuration, shown generally by the reference number 108. In this configuration 108, the coupling apparatus 42 is placed on the upper lid edge 88 with the back plate 44 on the outside surface 96 of the waste container 22. This allows the bin 10 to be coupled to the waste container 22, so that the bin 10 is inside the waste container 22 and out of site. The hidden mount configuration 108 allows someone to store both the waste container 22 and bin 10 in a smaller space.

Further, in this configuration 108, the grip end 14 or 16 of the bin 10 is placed in the v-shaped groove 58 so that the grip end 14 or 16 rests on the inner surface 72 of the receiver lip 68 and the outside surface 64 of the receiver back plate 60, which form the v-shaped groove 58 at a v-shaped groove angle 84 (see FIG. 3). The length of the receiver lip 68 is such that the recycling bin 10 will not slip off because the receiver lip 68 extends beyond the plane of the recycling bin 10 (as would fingers of a hand). The recycling bin 10, especially when full, will create a torque on the coupling apparatus 42 making it want to rotate about the upper lid edge 88. The coupling apparatus 42 is prevented from over-rotating due to the length of the receiver back plate 60. When the coupling apparatus 42 rotates, the inside surface 66 of the receiver back plate 60 contacts the inside surface 94 of the waste container 22 preventing it from over rotating so that the coupling apparatus 42 will support the recycling bin 10.

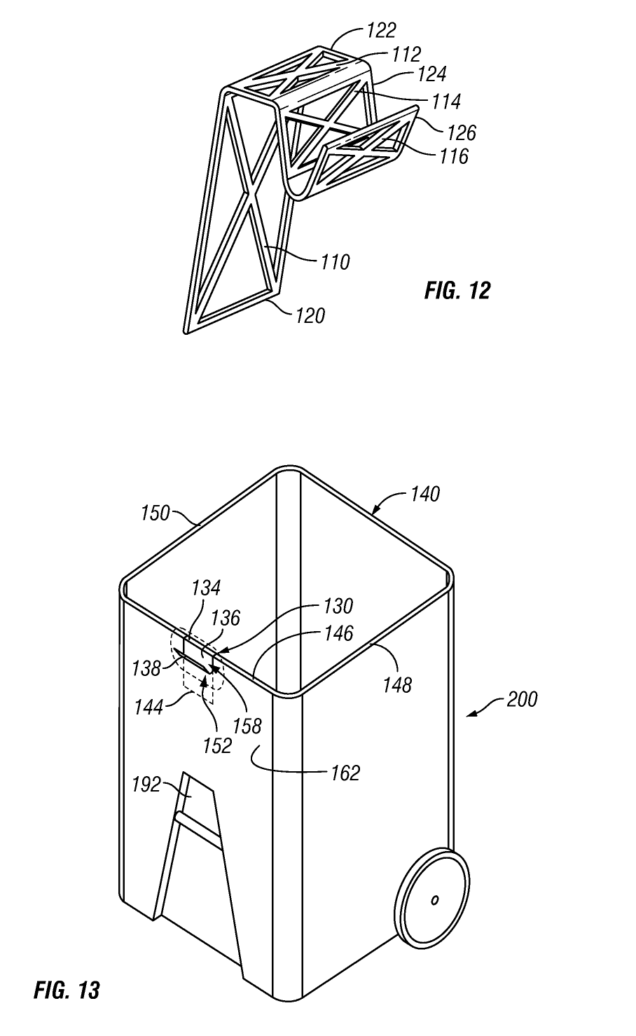

FIG. 12 illustrates another embodiment of the present invention. A coupling apparatus 118 is made of rigidly connected braces referenced by numbers 110-116. The back plate 120 can be constructed with a framed brace 110 or multiple braces rigidly connected (not shown). The extender 122 can be made of a framed brace 112 or multiple rigidly connected braces (not shown). The receiver back plate 124 can be made of a framed brace 114 or multiple rigidly connected braces (not shown). The receiver lip 126 can be made of a framed brace 116 or multiple rigidly connected braces (not shown). The elements (120, 122, 124, and 126) of the invention can be constructed in many different configurations or materials but the elements must be rigidly connected to prevent bending, twisting, and/or warping of the coupling apparatus 118.

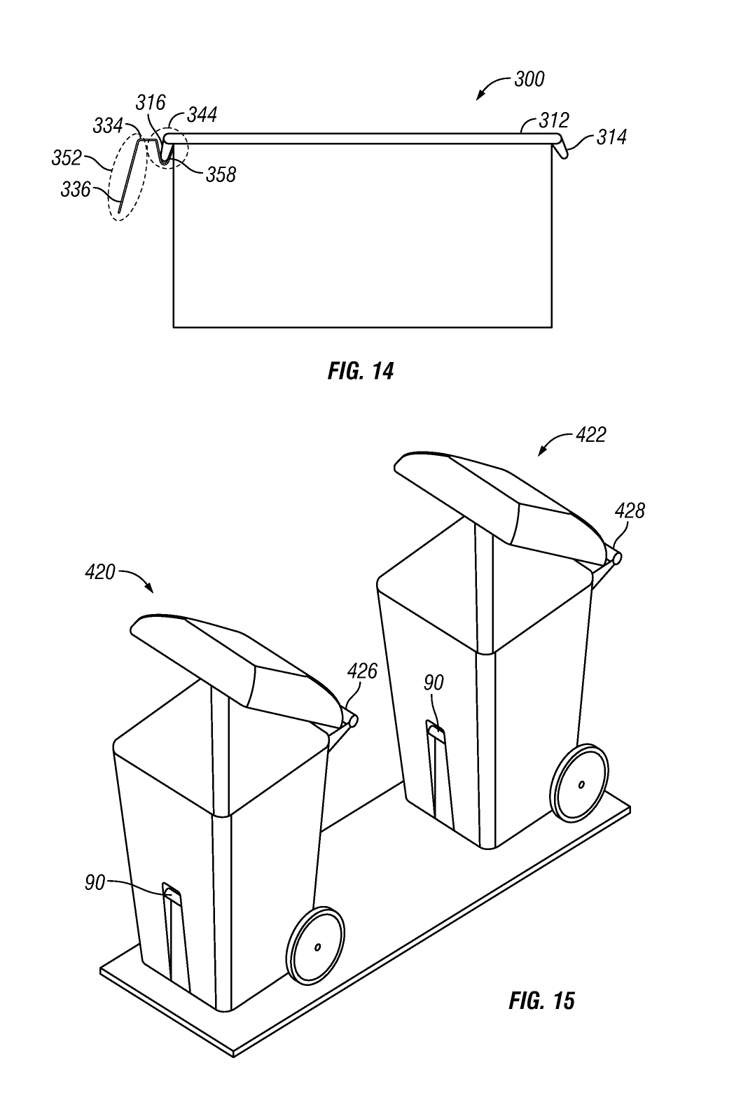

FIG. 13 illustrates a further embodiment of the present invention. A coupling apparatus 130 is affixed to a part of the container 200. The coupling apparatus 130 can be located on one or more sides of the container 200 as part of the upper lid edge 140 or the surface 192 behind the recessed bar 142. The back plate of the coupling portion 144 (shown by dotted lines) can be bolted to a wall of the container 200, it can be glued, or it can be made integral to the container.

WNW The container 200 can have the integrated or affixed coupling apparatus 130 at the front top edge 146 or either side top edge 148, 150 as long as the coupling apparatus is rigidly attached to or part of the container 200. The container 200 in the integrated configuration has a receiver group 152 rigidly attached to it.

The receiver group 152 includes an extender 134 that is rigidly attached to a receiver back plate 136 that over hangs the outside surface 162 of the waste container 200. Rigidly attached to the bottom of the receiver back plate 136 is a receiver lip 138. The receiver back plate 136 and the receiver lip 138 forms a v-shaped groove 158 with a v-shaped groove angle of about 30 degrees.

In this configuration the supporting of a recycling bin 10 operates as the embodiments detailed herein above except that when a recycling bin 10 is place in the v-shaped groove 158 the extender 134, receiver back plate 136, and receiver lip 138 are prevented from over rotating due to the integration or attachment of the “back plate” to a side of the container that holds the receiver group 152 rigidly in place.

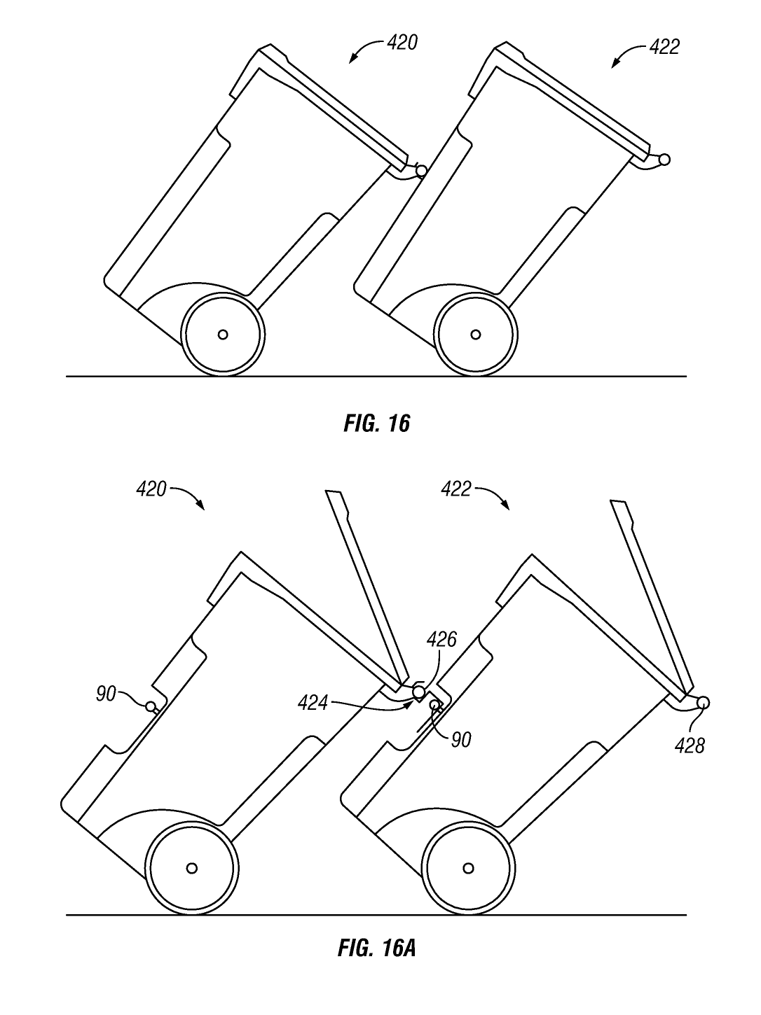

FIG. 14 illustrates a further embodiment of the present invention. A coupling apparatus 330 is affixed to a part of the bin 300. The coupling apparatus 330 can be located on one or more of the handles 314, 316 of the bin as part of the reinforced edge 312. The receiver lip 338 of the receiver portion 344 (shown by dotted lines) can be bolted to a handle 314, 316, it can be glued, or it can be made integral to the bin 300.

The bin 300 can have the integrated or affixed coupling apparatus 330 at either handle 314, 316 as long as the coupling apparatus is rigidly attached to or part of the bin 300. The bin 300 in the integrated configuration has a coupling group 352 and receiving group 344 rigidly attached to it.

The receiver group 352 includes an extender 334 that is rigidly attached to a receiver back plate 336 that is rigidly attached to an extender 334. Rigidly attached to the bottom of the receiver back plate 336 is a receiver lip 338. The receiver back plate 336 and the receiver lip 338 forms a v-shaped groove 358 with a v-shaped groove angle of about 30 degrees.

In this configuration the supporting of a recycling bin 10 operates as the embodiments detailed herein above except that when a recycling bin 10 is place in the v-shaped groove 358 the extender 334, receiver back plate 336, and receiver lip 338 are prevented from over rotating due to the integration or attachment of the “receiver lip” to the handle 314, 316 of a bin 300 that holds the receiver group 344 rigidly in place.

The present invention has many advantages over prior art devices. One advantage of the present invention is that the coupling apparatus 42, in a preferred embodiment, can be made of a single piece of metal providing rigidity and strength not found in prior art devices made of wire or the like. The coupling apparatus 42 is versatile and can be used in many different configurations including one that takes advantage of a recessed bar 90 that can be found on most waste containers 22.

Another advantage of the present invention over prior art devices is that the coupling apparatus 42 allows a full bin 10 to be attached to a waste container 22 without having to lift the entire bin 10 off the ground; only the grip end 14 or 16 of a bin 10 needs to be lifted to engage the coupling apparatus 42. The receiver group 76 of the coupling apparatus 42 engages a handle 18 or 20 of a bin 10 without overstressing or breaking the bin 10. A further advantage of the present invention is that the due to the weight of the bin 10 being spread across the entire width of the coupling apparatus 42, it will not bend or deform easily. Even further, the coupling apparatus 42 does not need to be adjusted, as prior art devices do, to avoid contact with unwanted parts of a bin 10.

Still another advantage of the present invention over a prior art device that has a frame that completely surrounds a bin 10, is that with the present invention, the bin 10 does not need to be lifted up and over the frame to be attached to a waste container 22. Also, when not in use the coupling apparatus 42 is smaller, can be made of a single piece, can be stored easier than the bulky prior art devices, does not require any adjustment, and is not prone to damage like the prior art devices. In the preferred embodiment of the present invention, the coupling apparatus 42 has no rivets, welds, or moving parts that can easily wear and break.

A further advantage of the present invention over prior art devices is that the coupling apparatus engages a grip end of a bin 10 which is designed to support the load of the bin 10 and its contents preventing breakage of bin. The coupling apparatus 42 of the present invention couples the bin 10 to a waste container 22 so that when the waste container 22 is at rest or is tipped to be rolled to a desired location the bin 10 is approximately level which minimizes spillage of its contents while in transit.

As alluded to above, yet another embodiment of the present invention allows for the coupling of two or more large, waste-size containers together, such as a wheeled waste container 422 and a wheeled recycling container 420, such as those now being employed in many towns and municipalities throughout the country that have switched to a single-stream recycling system. As shown in FIG. 15 these new recycling containers are generally 64 gallons and are substantially the same size and configuration as a standard waste or refuse container. As shown therein, rolling recycling container 420 and rolling waste container 422 each have handles 426, 428 for allowing a resident to tilt and roll the containers to the curb. Each of these containers may also have a recessed bar 90, as discussed above. It should be appreciated that these wheeled containers, both for refuse and recycling, may come in sizes other than 64 gallons. In view of the switch to single-stream recycling, an alternative embodiment of the present invention is capable of coupling two large, wheeled waste-size containers together, i.e., it can couple a large wheeled recycling container with a standard wheeled refuse container such that a resident need only take one trip to the curb to properly place recyclable items and refuse for pickup.

Referring to FIGS. 16 and 16a, an alternative coupling apparatus 424 according to the present invention is illustrated coupling rolling recycling bin 420 to rolling waste or refuse container 422. As with the bin coupling apparatus 42 described above, coupling apparatus 424 is especially adapted for use on a residential, rollout waste container 422. The coupling apparatus 424 is designed to hold or join a rollout recycling container 420, used for storing recyclable items, with a standard rollout refuse container 422, such that a rollout waste container 422 and a rollout recycling container 420 can be conveniently transported together in a single trip between a storage site in or near a home or business and a collection site near the street curb. It will be readily appreciated that the coupling apparatus 424 may be used for carrying/holding containers recycling containers 420 of different size and shapes, i.e., it is not necessary that the recycling container 420 be the same size or the exact same configuration as the waste container 422.

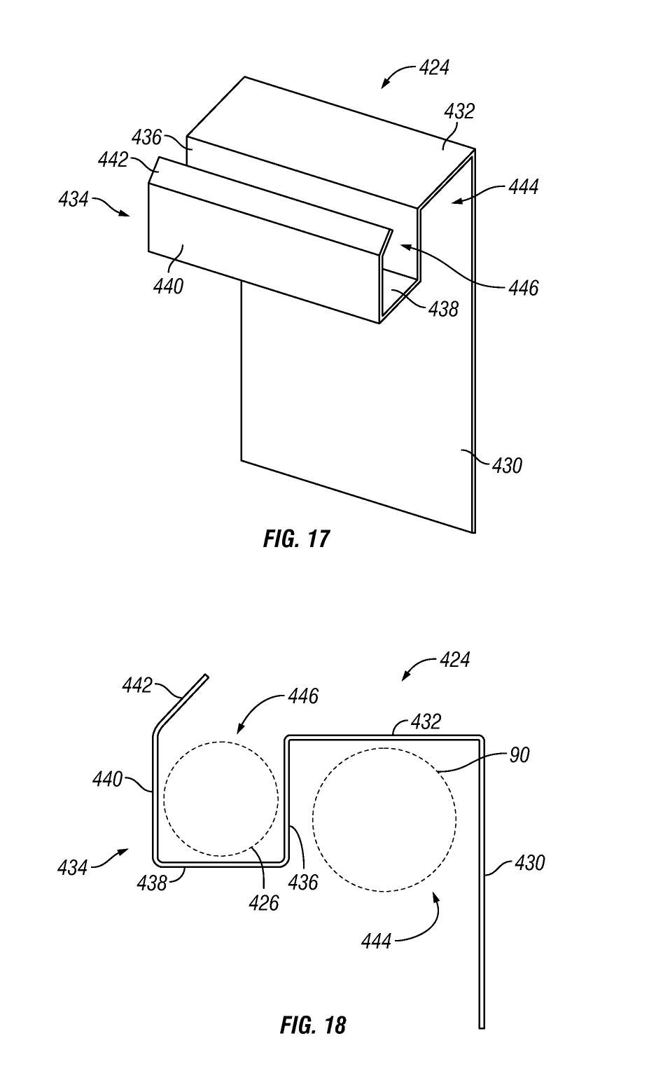

Turning now to FIGS. 17 and 18, the alternative coupling apparatus 424 of the present invention is shown. As shown therein, the coupling apparatus 424 is comprised of a single piece of bent metal such as, but not limited to, aluminum or steel. The coupling apparatus 424 may also be made of plastic or other suitable materials known in the art. The coupling apparatus 424 includes a back plate 430, a crossover portion 432 extending substantially transverse to said back plate 430, and a coupling portion 434. The coupling portion 434 is integrally formed with the crossover portion 432 and includes a first leg 436 oriented at a downward angle of approximately ninety degrees and generally parallel to the back plate, a second leg 438 transversely extending from the first leg 436 away from the back plate 430 and oriented generally parallel to the crossover portion 432, a third leg 440 extending from the second leg 438 at an upward angle of approximately ninety degrees and generally parallel to the back plate 430 and the first leg 436, and an angled retaining leg 442 extending from the third leg 440 at an upward angle of approximately forty-five degrees towards the back plate 430.

In the preferred embodiment, the back plate 430 is approximately 3½″ inches tall and the crossover portion 432 is 2″. A back plate 430 having these specifications enables sufficient contact and support against the first/leading container, and the crossover portion 432 having this dimension facilitates and enables connection to the trailing container, as described in detail below. With respect to the coupling portion 434, the first leg 436 spans approximately 1¼″ down, the second leg 438 1¼″ away from the back plate 430, the third leg 440 1¼″ up, and the angled retaining leg 442 ¾″ at a forty-five degree angle inwards, towards the back plate 430. The total length of all of the components of the coupling apparatus 424 is 10″ and the width is 4″, although other lengths and configurations of components are possible. It will be readily appreciated, however, that the coupling apparatus 424 may have components of slightly different specifications, and that the back plate 430, crossover portion 432 and first leg 436, second leg 438, third leg 440 and angled retaining leg 442 of the coupling portion 434 may be oriented at slightly different angles to one another than those disclosed above.

Alternatively, the coupling apparatus 424 is placed first on the metal rod/bar 90 of the leading container such that the rod 90 is received in channel 444, in the same manner as described above and shown in FIG. 10, and then the trailing container 420 is lowered so as to fit the handle 426 of the trailing container 420 within channel 446 of the coupling portion 434 of the coupling apparatus. In most applications, as the handle 426 of the trailing container 420 is received in channel 446, the ¾″ angled retaining leg 442 will snap over the handle 426, thereby locking the coupling apparatus 424 in place. Importantly, the angled retaining leg 442 permits the coupling apparatus to remain in place on the recycling container 420 (or trailing container) for the next usage when coupling container to container.

Alternatively, the coupling apparatus 424 can first be mounted on the recycling container (or trailing container) handle 426 (square or round configuration) and the container 420 may then be lowered or tipped so that the back plate 430 is positioned over/inside the recessed metal rod/bar 90 located in the middle of the trash container (or leading container) 422, in the same manner described above in connection with coupling apparatus 42. As will be readily appreciated, recessed bar 90 of the leading container 422 is received in channel 444 of the coupling apparatus 424.

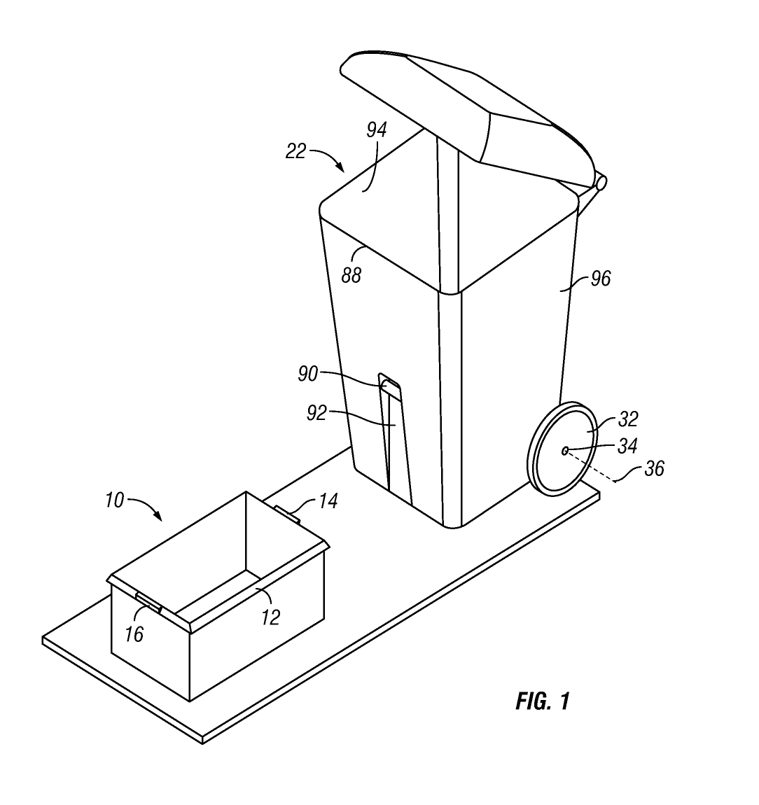

Importantly, the coupling apparatus 424 of the present invention is sized and configured to accommodate either the larger rollout recycling containers 420 such as those used in most single stream recycling systems, as well as the older style rectangular recycling bins 10. Indeed, the coupling apparatus 424 of the present invention still permits the coupling of a recycling bin 10 with a rolling refuse container 22, 420 in the same manner as discussed above in connection with FIGS. 1-14. This allows for a “one size fits all” coupling apparatus that permits the coupling of a recycling bin, be it a bin or a rolling container, to a standard rolling refuse container, provided at least one of the two containers is equipped with a metal rod 90 or the like in the center required to retain the back plate 430.

In addition to the coupling of a rolling recycling container to a rolling refuse container, multiple coupling apparatuses 424 may be employed to bring a combination of rolling containers and bins to the curb in a single trip. For instance, a rollout recycling container 420 and a rollout refuse container 422 may be coupled together using a coupling apparatus 424 in the manner heretofore described. In addition, another coupling apparatus 424 may be used on the lip of the recycling container 424 or on the bar 90 of the recycling container 424 to couple another rolling container or a recycling bin 10 in a manner similar to that shown in FIGS. 6-9. Accordingly, the coupling apparatus 424 of the present invention facilitates recycling and refuse collection by allowing a resident to couple an array of recycling and refuse bins and containers together so that they can be transported to the curbside in a single trip.

An additional advantage provided by the present invention is that, when coupled, the weight of the combined load (refuse and recycling) is distributed over two sets of wheels, i.e., fours wheels, thereby acting much the same as a wagon or flatbed. As such, the pulling force required to transport the two rolling containers together is considerably less than that required if the load were placed over a single set of wheels, i.e., two wheels. As will be readily appreciated, an operator will not need twice the pull force when the containers are coupled (assuming equal weight). Indeed, in certain instances less pulling force may needed to pull both containers than when compared to pulling the heaviest container separately. This is because the second (trailing) container lays forward and rests/is rigidly connected to the leading container which essentially distributes the total weight evenly (or near evenly) to all four wheels as if the load were carried on a wagon.

While the invention had been described with reference to the preferred embodiment, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A coupling apparatus for attaching a recycling container to a waste container, comprising:
a back plate having a length and a width that lies in a first plane;
a crossover portion rigidly connected to said back plate and lying in a plane approximately transverse to said back plate; and
a coupling portion rigidly connected to said crossover portion opposite said back plate, said coupling portion having a substantially U-shaped profile and sized to receive a handle of one of said recycling container and said waste container.

2. The coupling apparatus of claim 1, further comprising:
an angled retaining portion rigidly connected to said coupling portion and extending at least partially over said coupling portion such that said angled retaining portion at least partially closes said coupling portion.

3. The coupling apparatus of claim 2, wherein said coupling portion further comprises:
a first leg rigidly connected to said crossover portion and extending in a downward direction and lying in a plane approximately parallel to said back plate;
a second leg rigidly connected to said first leg and extending in a direction approximately perpendicular to said first leg and away from said back plate;
a third leg rigidly connected to said second leg and extending in a direction approximately perpendicular to said first leg and lying in a plane approximately parallel to said first leg and said back plate;
wherein said first leg, second leg and third leg define said substantially U-shaped profile.

4. The coupling apparatus of claim 2, wherein:
said crossover portion, said coupling portion and said angled retaining portion have a width coextensive with said back plate.

5. The coupling apparatus of claim 1, wherein:
said coupling apparatus is made of metal.

6. The coupling apparatus of claim 1, wherein:
said coupling apparatus is formed from a continuous piece of metal.

7. The coupling apparatus of claim 1, wherein:
said coupling device is formed from plastic.

8. The coupling apparatus of claim 3, wherein:
said back plate, said crossover portion and said first leg define a substantially inverted U-shaped channel for receiving a bar of the other of said recycling container and said waste container.

9. A coupling apparatus, comprising:
a back plate, said back plate defined by a length and a width and lying in a first plane;
a crossover portion extending from said back plate and lying in a second plane approximately transverse to said first plate;
a coupling portion extending from said crossover portion, said coupling portion including a first leg extending from said crossover portion, a second leg extending from said first portion, and a third leg extending from said second portion, said first leg, said second leg and said third leg defining an approximately U-shaped channel; and
an angled retaining portion extending from said third leg towards said back plate and over a portion of said U-shaped channel.

10. The coupling apparatus of claim 9, wherein:
said crossover portion, said coupling portion and said angled retaining portion have a width coextensive with said back plate.

11. The coupling apparatus of claim 9, wherein:
said coupling apparatus is made of metal.

12. The coupling apparatus of claim 9, wherein:
said coupling apparatus is formed from a continuous piece of metal.

13. The coupling apparatus of claim 9, wherein:
said coupling device is formed from plastic.

14. The coupling apparatus of claim 9, wherein:
said back plate, said crossover portion and said first leg define a substantially inverted U-shaped channel for receiving a coupling rod of the other of said recycling container and said waste container.

15. The coupling apparatus of claim 8 wherein said coupling apparatus further comprises rigidly connected braces.

16. A coupling apparatus for coupling a recycling container to a refuse container, comprising:
a first portion defining a first substantially U-shaped channel for receiving a handle of one of said recycling container and said refuse container;
a second portion defining a second substantially inverted U-shaped channel for receiving a recessed coupling rod of the other of said recycling container and said refuse container

17. The coupling apparatus of claim 16, wherein:
said first U-shaped channel lies adjacent said second U-shaped channel.

18. The coupling apparatus of claim 17, wherein:
said second portion includes a back plate, a crossover portion extending approximately transverse from said back plate, and a first leg extending from said crossover portion and lying in a plane approximately parallel to said back plate.

19. The coupling apparatus of claim 18, wherein:
said first portion includes said first leg, a second leg extending approximately transverse from said first leg, and a third leg extending approximately transverse from said second leg and lying in a place approximately parallel to said first leg.

20. The coupling apparatus of claim 16, further comprising:
a retaining leg extending from said first portion and extending at an angle at least partially over said U-shaped channel for retaining said handle within said channel.
